(19) United States
(12) Patent Application Publication
(10) Pub. No.: US 2002/0074926 A1
(43) Pub. Date: Jun. 20, 2002

(54) Single beam tracking tube

(76) Inventors: Marcellinus Petrus Carolus Michael Krijn, Eindhoven (NL); Oscar Hendrikus Willemsen, Eindhoven (NL); Nijs Cornelis Van Der Vaart, Eindhoven (NL)

Correspondence Address: Corporate Patent Counsel, U.S. Philips Corporation, 580 White Plains Road, Tarrytown, NY, 10591, US

(21) Appl. No.: 10/012,020

(22) Filed: Dec. 5, 2001

(30) Foreign Application Priority Data
Dec. 14, 2000 (EP) 00204511.0

(51) Int. Cl. H01J 29/50

(52) U.S. Cl. 313/409; 313/414

(57) ABSTRACT

Single beam color CRT of the beam tracking type having a display screen comprising a plurality of parallel phosphor lines, the CRT being equipped with a Distributed Main Lens type electron gun. The distributed main lens has a plurality of oblong grids which each have a single, oblong, beam passing aperture. The longitudinal axes of the grids and of the apertures are transverse to the direction of the phosphor lines. Correction means are provided to compensate for the astigmatism introduced by the main lens.

The invention relates to a display device comprising a color cathode ray tube of the beam index (or: tracking) type having a display screen with a plurality of parallel phosphor lines and a single beam electron gun.

Color selection in Cathode Ray Tubes is ensured by the use of a shadow mask. This mask is an expensive part of the CRT. Further, its transmission is limited to typically 20%. As a result, a relatively large current is required to obtain a prescribed brightness. The magnitude of this current limits the electron-optical performance.

The newly proposed mask-less CRT does not have these drawbacks. In this tube the electron beams are tracked along phosphor lines. The phosphor lines are alternating red, green and blue. Guidance of the beams along the aimed phosphor lines is ensured by active steering of the beams. For this, a feedback mechanism is used. For this type of tube, the name beam tracking tube or beam index tube is used.

To ensure color purity, it is essential that the spot size normal to the phosphor lines is sufficiently small. In practice, it is difficult to track three beams simultaneously. As an alternative to the three beam method one may use a single beam and write the three colors sequentially. In this case however, the beam current has to be three times as large as for the three beam option. As a consequence, space charge interactions may occur which detoriate the spot size and accordingly the color purity.

Therefore an object of the present invention is to provide a single beam tracking tube capable of high color purity, even at large beam currents. This object is achieved by a display device having a color cathode ray tube as described in claim 1. The invention is based on the insight that the detoriation can be compensated by increasing the opening angle of the beam. This increase in opening angle in its turn requires a gun with a main lens that has a large effective diameter in order not to suffer from spherical aberrations. In a CRT the grids which when energized produce a lens action are held in place in the neck of the CRT by a so-called multiform (glass rod) on either side of the grids. Since the multiforms take up room, the consequence of their presence is, that the grids have a substantially oblong shape. (For use in conventional three beam color CRT's each grid has three holes, or beam passing apertures, the shape of which is chosen such as to result in a circular lens for each of the three beams.) For use in a single beam gun, each oblong grid should have only one hole. Further, this hole should be as large as possible to result in the highest possible lens quality. In order to meet the above considerations, in a first step a design was chosen according to which the oblong grids comprise oblong beam passing apertures, the longitudinal axes of the grids and of the apertures coinciding. Moreover, the longitudinal axes are typically transverse to the direction of the phosphor lines. (Preferably. The direction of the phosphor lines is parallel to the longitudinal axis of the—rectangular—display screen, but the invention is not restricted thereto).

In practice, one has little room to enlarge the effective lens diameter, since the maximum lens diameter is determined by the inner diameter of the neck of the CRT. A second step in the the design is to employ a so-called Distributed Main Lens (DML). A DML is a lens comprising a plurality of metal grids (at least a first grid, a final grid and one intermediate grid) electrically connected by a (high-ohmic) voltage divider by which the main lens voltage is gradually and step-wise spread across the grids. The resulting potential distribution mimics that of a standard lens with a large diameter.

The oblong shape of the grids, as well as of the holes in the grids, results in a relatively large effective lens diameter in the y-direction, whereas the lens diameter in the x-direction is relatively small. As a consequence, the resulting lens strength in the y-direction is weaker than it is in the x-direction: the lens not being round causes the spot on the screen to be astigmatic. The invention also provides a solution to this problem. According to a first embodiment this astigmatism can be corrected with the dynamic focus created by a dynamic—astigmatism- and- focus (DAF) section, e.g. arranged at the beam entrance side of the main focus lens, like that present in electron guns used in high-end television tubes of the shadow mask type.

Use of a DAF section to compensate for the astigmatism caused by the main lens has however a drawback: it detoriates the lens quality in the y-direction to a certain extent. Two alternative and more preferred methods to compensate for this astigmatism are presented below.

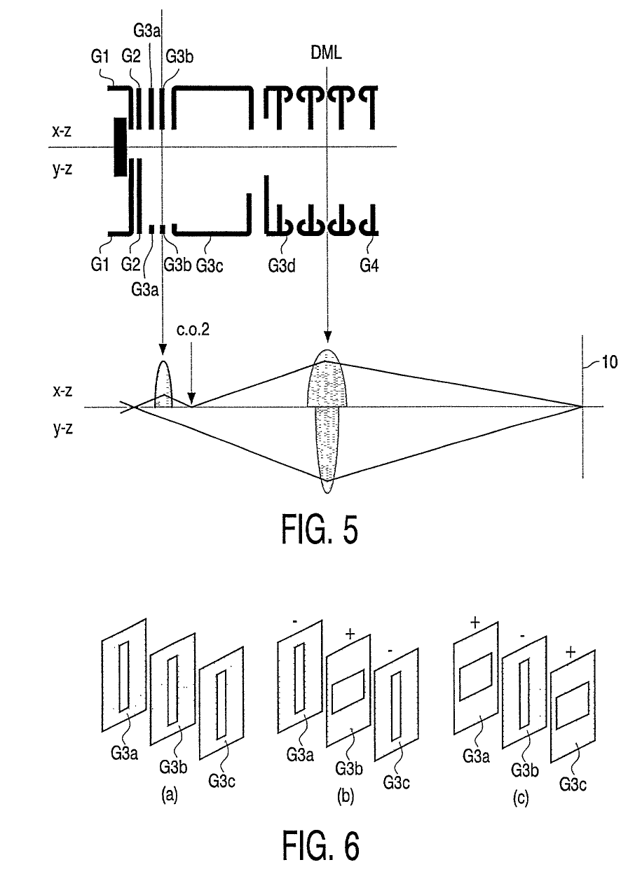

The first method is as follows: By means of adding at least one extra grid just beyond grid G₂, it is possible to create a cylinder lens in the x-z plane. An embodiment of this method is depicted in FIG. 5. When the strength of this cylinder lens is tuned properly, an extra crossover is created which compensates for the astigmatism caused by the DML. The layout of the grids needed to achieve the required lens action is depicted in FIG. 6a.

It is also possible to add to the aforementioned cylinder lens a weak quadrupole. The polarity of this quadrupole should be such that it diverges the beam in the y z plane in order to increase the lens filling in this plane (cf. FIG. 6a and 6b). A large lens-filling is imperative in order to benefit from the lens quality of the DML in the y-direction. The strength of the cylinder lens in the x-z plane should be adapted accordingly. Alternatively, the additional quadrupole could be located near the extra crossover caused by the cylinder lens. In this case, it has no effect in the x-z plane.

Instead of adding a weak quadrupole to increase the lens filling in the y-z plane, it is also possible to make an additional cross—over in the y-z plane and tune the lens filling by means of tuning the beam—divergence near this crossover.

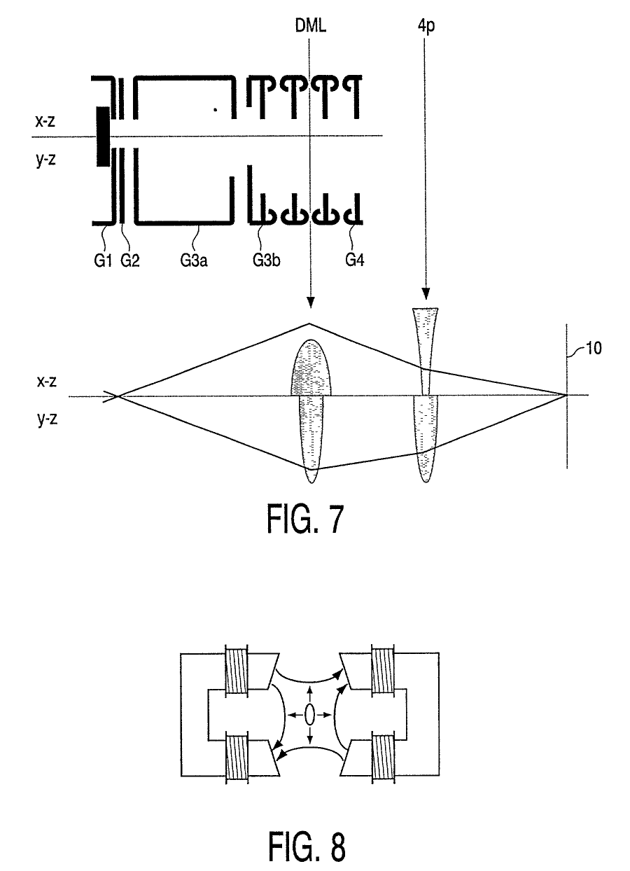

The second method consists of adding a magnetic quadrupole to compensate for the astigmatism introduced by the DML. In the preferred embodiment—depicted in FIG. 7—this magnetic quadrupole is located as close as possible to the screen without deteriorating the raster too much. It can advantageously be integrated with the deflection unit. The sign of the quadrupole should be such that it converges the beam in the y-z plane. In this way we achieve convergence of the beam on the screen as well as an improved spot size in the y direction. Since this quadrupole increases the opening angle in the y-z plane, it decreases the spot size in this plane. The optimum strength of this quadrupole could turn out to depend on screen position. Any spurious defocusing of the spot can be compensated for by the DAF.

These and other aspects of the invention will be apparent from and elucidated with respect to the embodiments described hereafter.

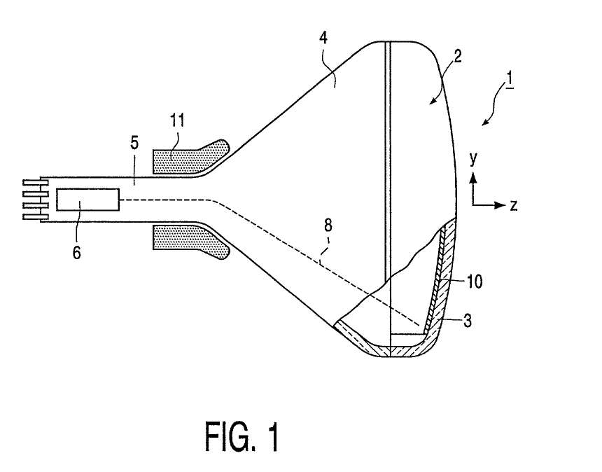

FIG. 1 is a diagrammatic cross-section of an embodiment of a mask-less picture display device;

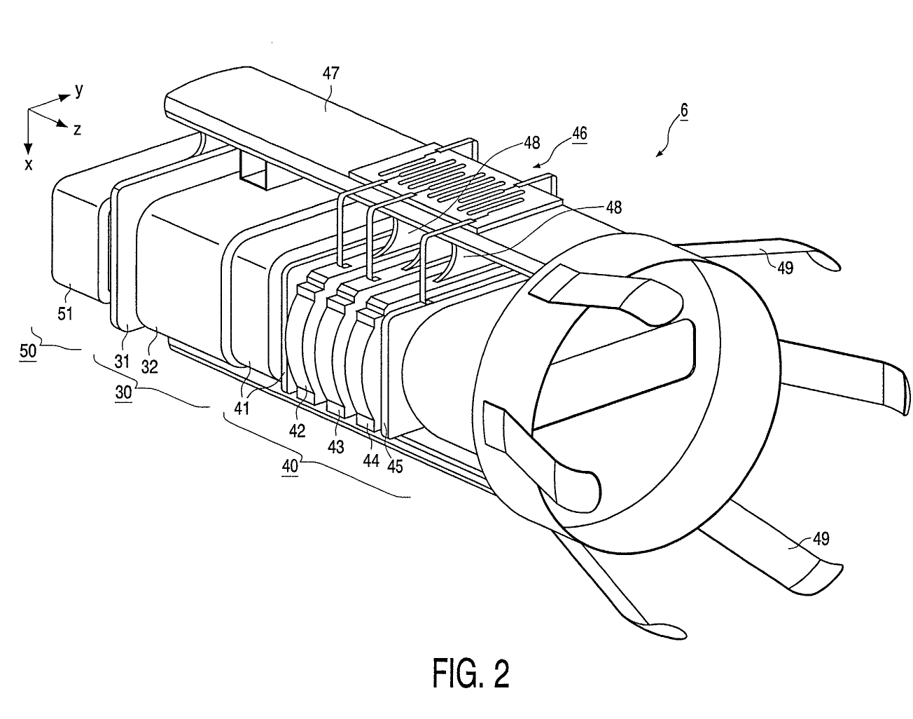

FIG. 2 is a perspective and larger view of the structure of a DML gun for use in the display device of FIG. 1;

FIG. 3 shows schematically a perspective view of a main lens system for use in the DML gun of the single beam type;

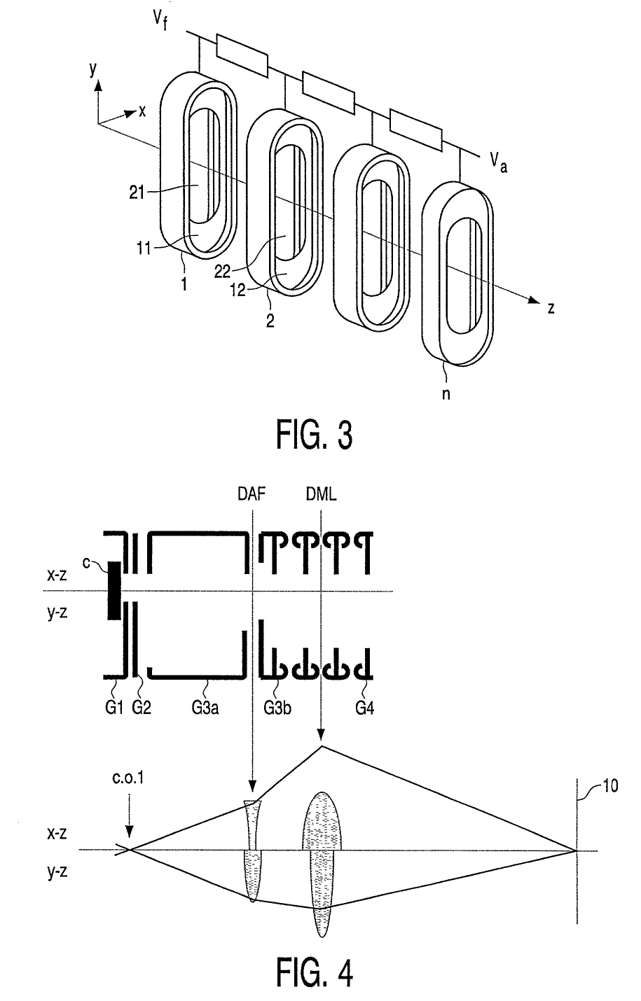

FIG. 4 shows the layout of a single beam DML gun, equipped with a DAF section, along the x-z plane and the y-z plane, respectively (upper part of the figure) and its lens characteristic (lower part of the figure);

FIG. 5 shows the layout of a single beam DML gun, equipped with a cylinder lens, along the x-z plane and the y-z plane, respectively and its lens characteristic (lower part of the figure)

FIG. 6 shows in perspective view three different grid assemblies (a,b and c) for producing a cylinderlens;

FIG. 7 shows the layout of a single beam DML gun, combined with a magnetic quadrupole lens;

FIG. 8 shows a means for producing a magnetic 4-pole field for use with the gun of FIG. 7;

The display device shown in FIG. 1 comprises a color cathode ray tube 1 having an evacuated envelope 2 comprising a display window 3, arranged normal the longitudinal tube axis z, a cone 4 and a neck 5. The neck 5 accommodates an electron gun 6 for generating a single electron beam 8. A display screen 10 is arranged on the inner surface of the display window 3, which has a longitudinal axis x and a transversal axis y. The display screen 10 comprises a plurality of parallel red, green and blue luminescing phosphor lines, which preferable extend parallel to the x-axis of the display window. Each group of (red, green or blue) phosphor elements forms a pattern. The display screen may alternatively comprise other patterns, such as a black matrix (a black pattern) or color filter patterns. Moreover, patterns with index elements are arranged in cathode ray tubes of the beam index type. On its way to the display screen 10 the electron beam is 8 is deflected across the display 10 by means of a deflection unit 11.

An electron gun 6 for use in the division of FIG. 1 is shown in perspective and greater detail in FIG. 2. It is shown in a position which is clockwise rotated over an angle of 90 degrees with respect to the position it has in FIG. 1. The gun 6 is of the type having a distributed main lens (DML). The gun 6 comprises an electron beam generating and forming portion 50 referred to as the triode part, which includes an electron source (cathode) C and an electrode 51, often referred to as GI, which usually is connected to ground. The gun 6 further comprises a prefocusing section 30 which includes two adjacent electrodes 31, 32 having operating potentials of typically 400-500 volts and 5-6 kV, respectively, which are usually denoted as G2 and G3, respectively. The electron-optical prefocusing lens which is formed by this system 31, 32 of electrodes provides a virtual image of the electron source C which serves as an object for a main focusing lens formed in a subsequent main focusing section section of the gun.

The main focusing section in this embodiment comprises a main lens system 40 having a first lens electrode 41, a final electrode 45 and three intermediate electrodes 42, 43, 44 across which a main lens voltage of typically 25-30 kV is applied during operation. The main lens voltage is distributed gradually and stepwise across the five electrodes 41-45 of the DML mail lens system 40. To this end the intermediate electrodes are interconnected by means of resistive voltage divider 46 and connected to the outer electrodes 41, 45 of the system. By this gradual and stepwise distribution of the main lens voltage across the five electrodes the potential jump between adjacent electrodes in the main lens system may remain limited, which has an extremely favorable effect on the lens action of the main lens. Thus, for example spherical aberrations can be adequately inhibited, even at larger beam currents, without an increase of the lens diameter being required.

The various parts of the gun 6 are held together at both sides by means of insulating (e.g. glass-ceramic) supports 47, which are often referred to as multiform rods or beading rods, and are fixed with respect to each other. Securing means 48 are used with which the electrodes are pressed into the insulating supports 47 at an (elevated) temperature at which the supports are in a slightly fluid condition. The gun assembly further comprises a plurality of radially arranged centering springs 49 with the gun 6 is centered in the neck 5 of the tube.

FIG. 3: Schematic of a distributed-main-lens (DML) for a single-beam gun. The lens consists of a multitude of metal grids interconnected by a high-Ohmic voltage divider (also called bleeder). The (oblong) grids 1, 2, . . . n have annular walls, so that they form a sort of boxes, without a bottom and a lid. Instead they comprise transversal intermediate 11, 12 . . . in which (oblong) beam passing apertures 21, 22 . . . are provided. The grids 1, 2, . . . n are al least on one side provided with a flange and their cross-section may be e.g. rectangular, oval etc. Also the beam apertures 21, 22 . . . may be e.g. rectangular oval etc. The multiforms connecting the grids are not shown. Since the physical dimensions of the grids are larger in the y-direction than they are in the x-direction, the lens quality in the y direction exceeds that in the x-direction. The lens strength on the other hand is smaller in the y-direction than it is in the x-direction, resulting in an astigmatic spot on the screen. Note that the lens has been rotated over 90 degree with respect the orientation in a standard color gun. We consider the case in which n≦2.

FIG. 4 Typical layout of a conventional gun provided with a DML (upper part of figure). Since the lens-strength is much stronger in the x-direction than it is in the y-direction, it has to be compensated. In this case, a DAF section has been used to take care of this compensation. The equivalent lens model is also shown (lower part of figure).

A DAF-section includes two apertured electrodes (not shown) which, when a (dynamic) control voltage is applied to at least one of them, produce an electric quadrupolar field between them. The electrode apertures usually are rectangular and cross each other. How the voltage is applied depends a.o. on their mutual orientation.

FIG. 5: Layout of a single-beam gun equipped with a DML (upper part of figure). The astigmatism caused by the DML is compensated by adding a cylinder lens in the x-z plane close to the triode section of the gun. The purpose of the cylinder lens is to create an extra crossover (C.O.2). The equivalent lens model is shown in the lower part of the figure.

FIG. 6: Examples of structures of grids required to create an extra crossover in the x-z plane. The structure depicted in (a) constitutes a cylinder lens in the x-direction. The same holds for the structures (b) and (c), with the difference however that the effect of a quadrupole lens in superposed in order to slightly diverge the beam in the y-z direction.

FIG. 7: Layout of a single-beam gun equipped with a DML in which the astigmatism caused by the DML is compensated by a magnetic quadrupole positioned near the deflection coil. The equivalent lens model is shown in the lower part of the figure.

1. Display device comprising a color cathode ray tube of the beam Index type having a display screen with a plurality of parallel phosphor lines and an electron gun, characterized by a single beam electron gun which comprises a main focus lens, said main focus lens including a plurality of oblong grids, each grid having a single, oblong, beam passing aperture, the longitudinal axes of the grid aperture and the grid being parallel and extending transverse to the direction of the phosphor lines.

2. Display device as claimed in claim 1, characterized in that the main focus lens is a distributed main lens.

3. Display device as claimed in claim 1 or 2, characterized in that the electron gun is provided with means for correcting beam astigmatism.

4. Display device as claimed in claim 3, characterized in that the correction means comprises a dynamically controllable astigmatic focus lens (optionally arranged at the beam entrance side of the main lens).

5. Display device as claimed in claim 3, characterized in that the correction means comprises a cylinder lens having its main lens action in a plane normal to the longitudinal axes of the grid apertures (optionally arranged at the beam entrance side of the main lens).

6. Display device as claimed in claim 3, characterized in that the correction means comprises a dynamically controllable magnetic quadrupole lens.

7. Display device as claimed in claim 6, characterized in that the magnetic quadrupole lens is arranged between the main lens and the screen.

8. Display device as claimed in claim 7, characterized in that the magnetic quadrupole lens in operation converges the electron beam in a plane through the longitudinal gun axis and the longitudinal axes of the grid apertures.

9. Display device as claimed in claim 5, characterized in that the cylinder lens is adapted to produce in operation an electric quadrupole.

10. Display device as claimed in claim 9, characterized in that the electric quadrupole in operation diverges the electron beam in a plane through the longitudinal gun axis and the longitudinal axes of the gun apertures.
